(19) United States
(12) Patent Application Publication
(10) Pub. No.: US 2012/0022776 A1
(43) Pub. Date: Jan. 26, 2012

(54) Method and Apparatus for Advanced Intelligent Transportation Systems

(76) Inventor: Javad Razavilar, San Diego, CA (US)

(21) Appl. No.: 13/154,528

(22) Filed: Jun. 7, 2011

Related U.S. Application Data
(60) Provisional application No. 61/397,239, filed on Jun. 7, 2010.
(60) Provisional application No. 61/397,238, filed on Jun. 7, 2010.

(51) Int. Cl. G06F 17/30; G01C 21/34

(52) U.S. Cl. 701/200; 707/769; 707/E17.014

(57) ABSTRACT

An intelligent transportation system that utilizes identification codes, databases and preprogrammed action steps contained within those databases is presented. The system thereby allows rich transportation communications to be made to the operators of vehicles while making optimum use of available networking bandwidth.

### CROSS-REFERENCE TO RELATED APPLICATIONS

This application claims benefit of provisional patent application 61/397,239 titled Method and Apparatus for Advanced Intelligent Transportation Systems (AITS) Based on Joint Routing and Navigational Optimization Techniques Combined with 3G/4G Wireless Communications systems by the same inventor Filed Jun. 7, 2010 and the benefit of patent application 61/397,238 titled Method and Apparatus for vehicles Advanced Technology Wireless Systems Features (VATWSF) by the same inventor filed Jun. 7, 2010.

### BACKGROUND OF THE INVENTION

1. Technical Field

The present invention relates to apparatus for an intelligent traffic management and transportation systems and methods to use the same.

2. Related Background Art

There are numerous means of communicating needed information to drivers of automobiles. Simple mechanical signs such as stop, yield or railroad crossing are gradually giving way to electronic information displays of speed limits, accidents and road conditions and estimated travel time to way points. Electronics within the vehicles are also being deployed to provide for example video views of the area surrounding a vehicle and location via global positioning satellites. Although localized radio broadcasts of traffic or other localized information have existed for several years, the link between the outside infrastructure of the road system and status and the inside the vehicle electronics and displays has been slow to develop.

Recent years have seen the field of wireless communications and its services mature substantially and resulted in enormous amount of advances and explosion in wireless communications services such high speed downlink packet access (HSDPA) and high speed uplink packet access (HSUPA) which have made full Internet connections at fast vehicular speeds a reality. Namely the introduction of advanced third generation (3G) systems and services such as 1x-EVDO, HSDPA, and HSPA+, also the introduction of fourth generation (4G) systems and services have contributed immensely to realization and deployment of wireless Internet at vehicular speeds in commercial 3G/4G networks throughout the world. These new communication technologies have resulted in ad hoc connections between the road system infrastructure and the inside of the vehicle. GPS, smart phones and portable computing devices can now be linked through wireless Internet connections to web page information that is relevant to the vehicle's operators and occupants.

Government agencies worldwide have been researching more structured approaches to providing an intelligent transportation system infrastructure. FIG. 1 shows a proposed architecture for such a system from research done at the United States Department of Transportation over the last twenty years. (See: Ram Kandarpa, Mujib Chenzaie, Justin Anderson, Jim Marousek, Tim Weil, Frank Perry, Ian Schworer, Joe Beal, Chris Anderson, Final Report: Vehicle Infrastructure Integration Proof-of-Concept Technical Description—Infrastructure, Research and Innovative Technology Administration (RITA) U.S. Department of Transportation 1200 New Jersey Avenue, SE Washington, D.C. 20590, February, 2009.) As can be seen in the Figure there are multiple components both within the vehicle and outside of the vehicle that all require complex communication protocol. The roadside equipment (RSE) is controlled and sends and receives communications from a service delivery node (SDN), which in turn is administered from an enterprise network operations center (ENOC). The ENOC is seen to administer certificate authority directly to the on board equipment (OBE) to ensure secure, private communication between the vehicle and the AITS. Both the OBE and the RSE are located using external data sources such as that provided by global positioning satellites (GPS). A common feature is rich information content communicated both from roadside devices to the vehicle and from the vehicle to other vehicles or to the roadside and networked infrastructure. The multiplicity of complex communications requires handshaking and security protocols to protect privacy while ensuring the intended traffic information message reaches the targeted vehicle. The complexity of the system has resulted in a system that is slow to be adopted. The time to adopt standards and devices for implementation is being outpaced by developments in the commercial and consumer communication networks. The system provides such a rich capability of communication that there is a danger of insufficient bandwidth on a crowded highway where every vehicle is trying to download information. As vehicle operators become more dependent upon electronically transmitted information that could include safety and regulation information reliability of certain transmission becomes paramount. The complexity of the proposed systems has resulted in a feature rich vision that has been proven too complicated to be adopted.

There is a need for a simpler system that can be implemented quickly and economically. It should require minimal changes or additions to the infrastructure, but can be upgraded and it should provide alternative information pathways to optimize use of the wireless information networks' bandwidth.

### DISCLOSURE OF THE INVENTION

An infrastructure architecture including equipment and methods of use for an information and control system for vehicle and pedestrian traffic is disclosed. Embodiments of the system include a radio beacon that is coupled with a receiving device in which the beacon signal is encoded for the receiving device to take some action. In one embodiment the receiving device may light up or beep or otherwise signal the vehicle operator or pedestrian of some information. The information may include that the vehicle or pedestrian is in the region of a traffic signal that is in a given state or that the speed limit in their location is set at a particular value or that there is an attraction of interest in the region. The information may in fact be any information that is otherwise presented to vehicles and pedestrians presently using conventional signage and signals as well as time changing information that may not be currently available with today's technology. The invention is applicable to any situation where a moving person needs to receive information. The movement may be via a vehicle such as a car, a bicycle or other or simply a person walking. The description that follows uses for exemplary purposes a moving vehicle which is not intended to limit the scope to that example alone.

In one embodiment the radio beacon is a cellular device operating on a 3g or 4g network and capable of being programmed to transmit a particular signal or information stream. In another embodiment the radio beacon is also programmed to provide control for a traffic signal to which it is attached. In another embodiment the beacon is attached to a display that may be programmatically changed based upon communication received by the beacon. In another embodiment the display is an array of light emitting diodes that enables a single format of display to be programmatically changed to multiple functions. Exemplary functions include a stop sign, a traffic light, a speed limit sign, a yield sign and others.

In another embodiment the receiving device includes or is coupled to computation capabilities that enable the device to compare the signal received to a look-up table of codes and the device is then programmed to take appropriate action based upon the indication in the table for the particular code. In another embodiment the radio beacon is programmed to send a particular coded signal based upon the state of a traffic signal. In a traffic light embodiment a first code is sent when the state of the traffic light is red and a different code is sent when the traffic light is yellow and a third code is sent when the traffic light is green. In another embodiment a code is sent to indicate a speed limit in the region of the beacon. The speed limit may be programmatically altered by changing either the code that is sent from the beacon or changing the corresponding entry in the look-up table of the onboard memory in the vehicle. In another embodiment the lookup table is time dependent. For example information displayed to the vehicle operator may reflect changing speed limits during the day as may be applicable to school zones or changes based upon normal repeating traffic patterns.

In another embodiment the beacon may also be mobile and the beacon incorporates a communication device such as a pager or other means to access a cellular network. This enables a form of asset tracking in that the beacon and the receiving unit within the vehicle are paired. The receiving unit device is pre-programmed to allow the separation distance from the owner to be set in certain range and if that range is exceeded the owner is immediately notified through a paging notification via 3G/4G network on his credit card size pocket device.

A fixed beacon with precisely known location enables a simple and extremely low cost means of establishing location tracking without resorting to global positioning or cellular networks. In another embodiment the receiving unit in the vehicle includes location and route information. The database coupled with the receiving device in the vehicle further includes traffic information for the locale of the beacon. A routing system within the vehicle may therefore use frequently updated dynamic traffic information to compute and update the best routes and shortest path and shortest travel time routes. Selected route may be modified to avoid congested areas and for doing so re-compute the routes with the best optimized ones.

In another embodiment the speed limits determined by the combination of a uniquely identified location beacon, the receiving unit in the car and the associated database the car is coupled with control units for the vehicle's speed such that the vehicle is automatically slowed when approaching congestion or danger. In another embodiment the unit may proactively enforce regulated speed limits.

In another embodiment a beacon that transmits encoded information related to the state of a traffic light may be coupled through the vehicle receiving unit to help slow the vehicle when approaching a stop sign or red traffic light.

The architecture of the described system allows introduction in phases and optimized use of available networked bandwidth. A simple radio beacon and receiving unit that reacts specifically to the beacon signal may be upgraded later with programmable receiving units in the vehicle and programmable beacons. The beacons may be associated with simple mechanical displays such as a traffic stop sign, or may be associated with a changing display such as a traffic light and the transmitted beacon signal may reflect the state of the traffic light. In some embodiments the beacons are more sophisticated and use a cellular enabled beacon that also is able to control the state of the traffic display. Changing both radio transmitted and visual display of for example a traffic light state, a speed limit or approaching traffic conditions.

### BRIEF DESCRIPTION OF THE DRAWINGS

FIG. 1 is a block diagram of a proposed prior art advanced intelligent transportation system architecture. (Ram Kandarpa, et al, Final Report: Vehicle Infrastructure Integration Proof-of-Concept Technical Description—Infrastructure, Research and Innovative Technology Administration (RITA) U.S. Department of Transportation 1200 New Jersey Avenue, SE Washington, D.C. 20590, February, 2009.)

FIG. 2 is a block diagram of a first minimally connected embodiment.

FIG. 2A is a block diagram of an included computing device.

FIG. 3 is a flow chart for a method to use a first minimally connected embodiment.

FIG. 4 is a block diagram of a network and GPS connected vehicle embodiment.

FIG. 5 is a flow chart for a method to use the embodiment of FIG. 4.

FIG. 6 is a flow chart for a second method to use the embodiment of FIG. 4.

FIG. 7 is a block diagram of a network and GPS connected vehicle and network connected beacon embodiment.

FIG. 8 is a flow chart for a method to use the embodiment of FIG. 7.

FIG. 9 is a block diagram for a mobile beacon embodiment.

FIG. 10 is a flow chart for a method using the asset tracking embodiment of FIG. 9.

### MODES FOR CARRYING OUT THE INVENTION

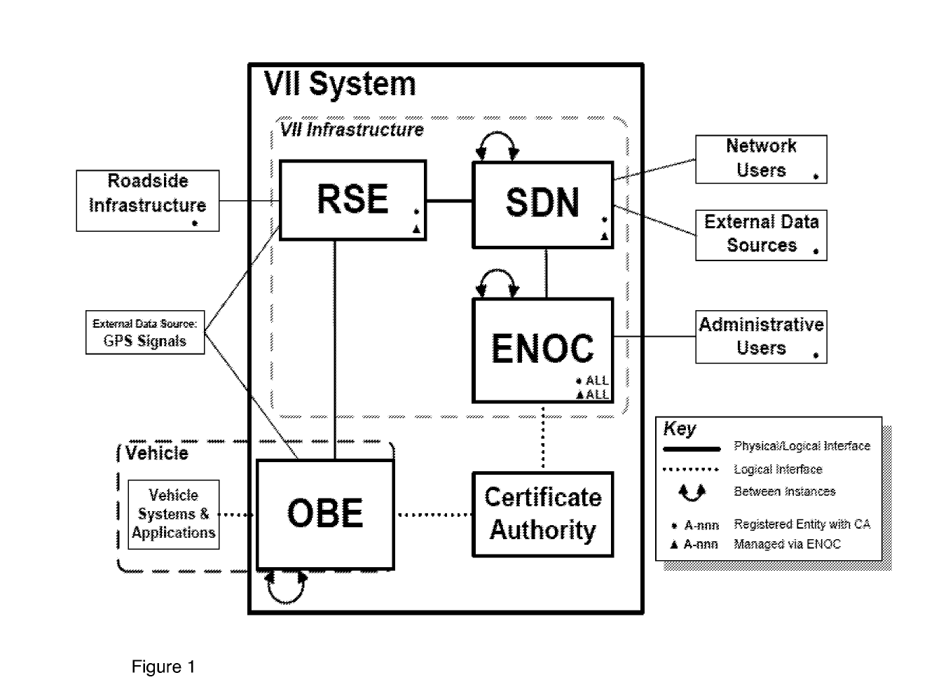

Embodiments of the invention may be described and contrasted to a proposed proof of concept architecture depicted in FIG. 1. The Vehicle Infrastructure Integration (VII) system shown in FIG. 1 contains aspects that are modified and improved in the current invention. VII system includes roadside equipment (RSE) that is interconnected to On Board Equipment (OBE) and vehicle systems and applications including computation, display and control capabilities in the vehicle. Service nodes (SDN) enable connection to a networked Enterprise Network Operating Center (ENOC). Both the Roadside equipment (RSE) and the on board equipment within the vehicle (OBE) include connections to global positioning satellite for location determination. Information other than GPS that is to be transmitted to the OBE is administered by the ENOC and passes through the service nodes (SDN) and the road side equipment (RSE) to the on board equipment (OBE). This implies that information rich signals are distributed by the RSE. All aspects of the system require high bandwidth for these information rich transmissions. This places significant strain on the communication infrastructure required to support over 200 million vehicles simultaneously in the United States alone. The current invention significantly simplifies such a system by making use of preset communication databases and lower bandwidth requirements on all phases of the system.

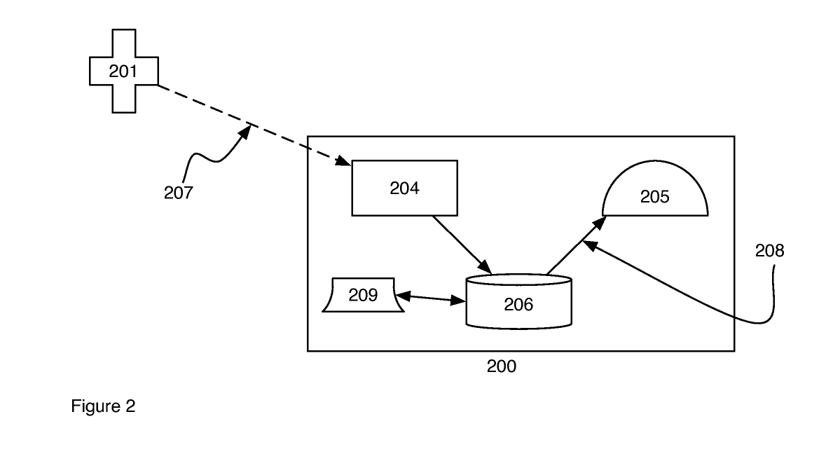

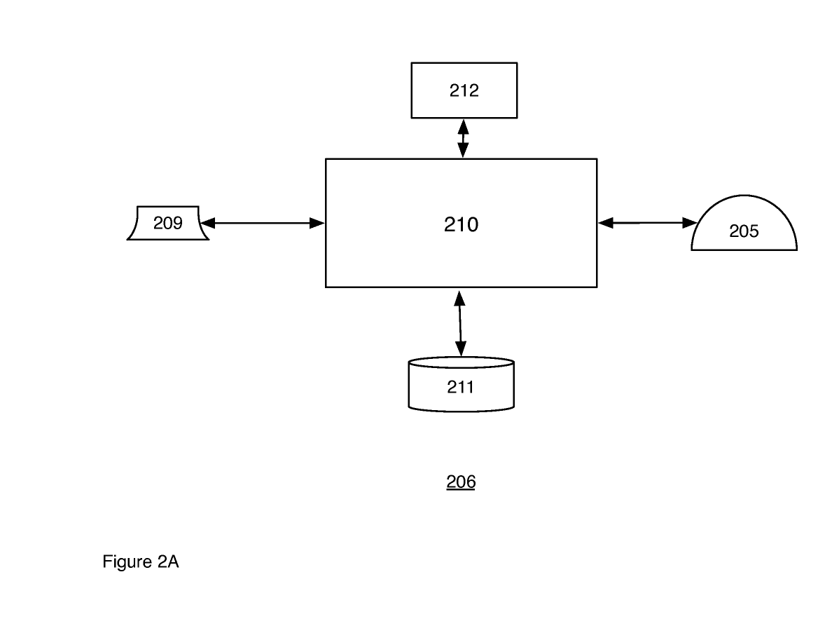

Referring to FIG. 2, a first embodiment includes a roadside beacon 201 that wirelessly 207 sends a signal to an onboard receiver 204 located within the vehicle 200. Non-limiting exemplary beacons include those known in the art such as non-directional navigational beacons previously used for instrument landing guidance for aircraft, IEEE 802.11 WI-FI beacons, AX.25 packet radio beacons, cellular based pager signals and 3g and 4g cellular information transfer, wireless internet protocols and Bluetooth® signals. (Bluetooth is a registered trademark of Bluetooth SIG Inc.) In a first embodiment the beacon transmits an identification code (ID) unique to the beacon. The identification code may be encoded in any telemetry means known in the art to send a particular identification by the beacon signal of choice. In this embodiment the bandwidth requirements of the roadside equipment beacon is small as the requirement is limited to broadcasting a simple identification code. The beacon is not relied upon to send the rich information content. The bandwidth requirements locally between the roadside equipment beacon and the onboard equipment receiver are more easily met. The receiver is connected to a on board computing device 206 that includes memory to contain a database of identification codes and corresponding information related to that code. Exemplary computing devices include central processing units typically incorporated into personal computers such as those manufactured by companies such as Intel and Advanced Micro Devices, and microcontrollers such as the PIC® microcontroller series manufactured by Microchip Technology Inc. Referring to FIG. 2A, the components of the computing device 206 or computing device include a processor 210 connected to a display device 205, previously discussed and a user interface 209 also previously described. The processor is further connected to memory 211 that may contain traffic control data in a database including location information and identification codes for vehicles, beacons and servers as well as program code that to control the computing device. The system also includes an Input/Output interface 212 that includes both wired and wireless connection to other computers, networks, control devices for the vehicle.

Information in the database that is relate to a particular code be it a beacon identification code, vehicle identification code or both includes the type of road infrastructure equipment the beacon may be associated with, the location of the beacon and actions that should be taken when a signal is received from a beacon having this particular identification code. Exemplary content of a database is shown in Table 1. Information transmitted between the beacon and the vehicle and in later embodiments between the vehicle, the beacon and a server and between different vehicles is collectively known as traffic control information. Traffic control information includes identification codes, infrastructure information and programming steps that may be used to control onboard vehicle computing devices, the actions of the beacon and the actions of the intelligent traffic system servers.

TABLE 1
Beacon Identification Database

| | | | | Actions to be |
|---|---|---|---|---|
| Beacon ID | Latitude | Longitude | Infrastructure | taken |
| 11adl | 40.10594 | −74.93851 | Stop Sign | Display stop sign |
| 12adf | 40.10527 | −74.9391 | Bus stop | Display Bus Stop |
| | | | | Sign |
| 123dsw | 40.1123 | −74.8884 | One way road | Alarm stop; stop |
| 145www | 41.1234 | −75.9905 | Dry Cleaner | IF (calendar pick |
| | | | | up dry cleaning) |
| | | | | THEN (display |
| | | | | reminder) |

The computing device 206 is further connected to a display unit 205. Exemplary display units include light emitting diode and liquid crystal displays as are typically used with computers and handheld devices. In one embodiment the display unit is simply a light that when turned on signals the driver of a particular situation perhaps an approaching stop sign. In another embodiment the “display” includes an audio alert. The dashed lines in this and subsequent Figures (e.g. 207) represent wireless communication links and the solid line (e.g. 208) represent direct wired communication links. The arrow(s) on the lines indicate the direction(s) of the communication. Notwithstanding the previous sentence it is understood that wired and wireless communication links are in many applications becoming interchangeable and as such the links depicted in the Figures should be interpreted accordingly. The onboard system further includes a user interface 209. Exemplary user interfaces include keyboards, touch screens, buttons, scrolling devices and other user interfaces typically used with computing devices, cell phones, personal data assistants known in the industry.

In another embodiment the receiving unit 204, the computing device 206 and the display unit 205 are integrated into a single device. In one embodiment that device is a cell phone. In another embodiment that single integrated device is a laptop computer or a personal computer or a tablet computer. In these latter cases the receiving unit may be the cellular network or Bluetooth capabilities of the integrated device. The corresponding beacon in the cases of this paragraph would then broadcast signals appropriate for the device be it cellular 3g or 4g signals, a Bluetooth signal or a wireless internet signal.

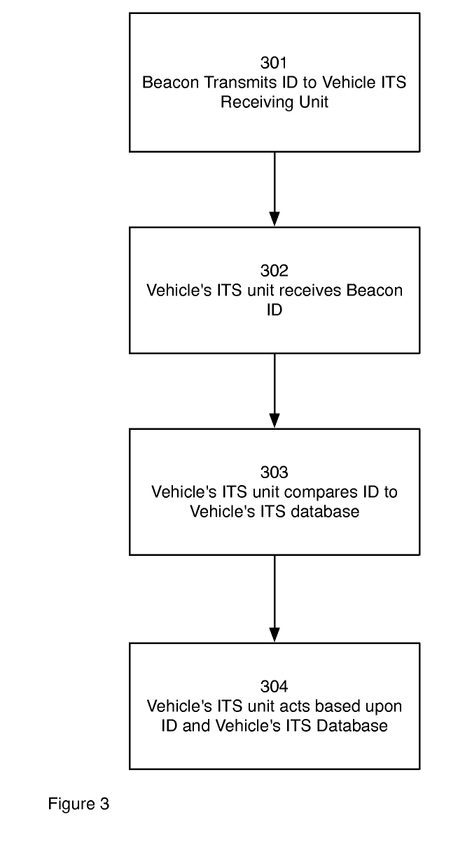

Referring to FIG. 3, the beacon transmits a traffic control information signal coded with an identification code. The transmission is a broadcast signal. The Beacon in this embodiment is unaware of vehicle presence or lack thereof. The vehicle ITS receives the beacon signal 302 and compares the beacon identification code with the entry in the vehicle ITS database 303. Based upon the entry the vehicle ITS computing unit is pre-programmed to take a display action.

As an example using the entries of table 1 a stop sign beacon is located at latitude 40.10594, longitude −74.93851 and is transmitting an encoded id of 11adl. The vehicle-receiving unit will receive this signal when it comes within radio range of the beacon. Once received the onboard computing device will compare the id 11adl with entries in its on board database and become aware that it is near the enumerated latitude and longitude location and the beacon is a stop sign. In the example of table 1 the computing device 206 is then programmed to display a stop sign on the in vehicle display 205. The appearance of the stop sign will help alert the driver that they are approaching an intersection and should slow down. It is seen in this first embodiment that access to an infrastructure network is not required. A simple non-connected beacon can result in a pre-determined message to be displayed within the vehicle. The complexity of the message and the amount of data displayed is not limited to the simple stop sign or signal display as discussed. The display actions to be triggered are limited only by the capabilities of the computing and display device and the imagination of the programmer. Based upon reception of the beacon signal identification code the computing system could just as easily display commercial establishments in the region of the beacon. In another embodiment the computing system is programmed to display information personal to the vehicle operator an example is we just drove by grandma's house or we just passed by a location of any other special interest to the vehicle operator. In another embodiment the choice of the action to be taken on receipt of a particular beacon identification code may be programmatically changed with time of day or date. In another embodiment the beacon identification code is programmatically changed with weather conditions. A non-limiting example of weather conditions includes temperature. In this later embodiment the beacon further includes electronic means (not shown) to measure the local temperature as are well known in the art and when the temperature drops below freezing the beacon identification code is changed to correspond to a message in the vehicle database to warn of potential icing on the roadway. In another embodiment shown in the identification code line 145www of Table 1, a beacon identification code is associated with a location that is also associated with a calendar event. The action to be taken is a display of a reminder of calendar event. A non-limiting example is a calendar event established in the database of the onboard computing device related to picking up clothes at a dry cleaner. The beacon identification code is associated in the database with the dry cleaner establishment in the locale of the beacon. The associated action of the computing device is a reminder to pick up clothes when the vehicle drives near a beacon associated with the locale of the dry cleaner.

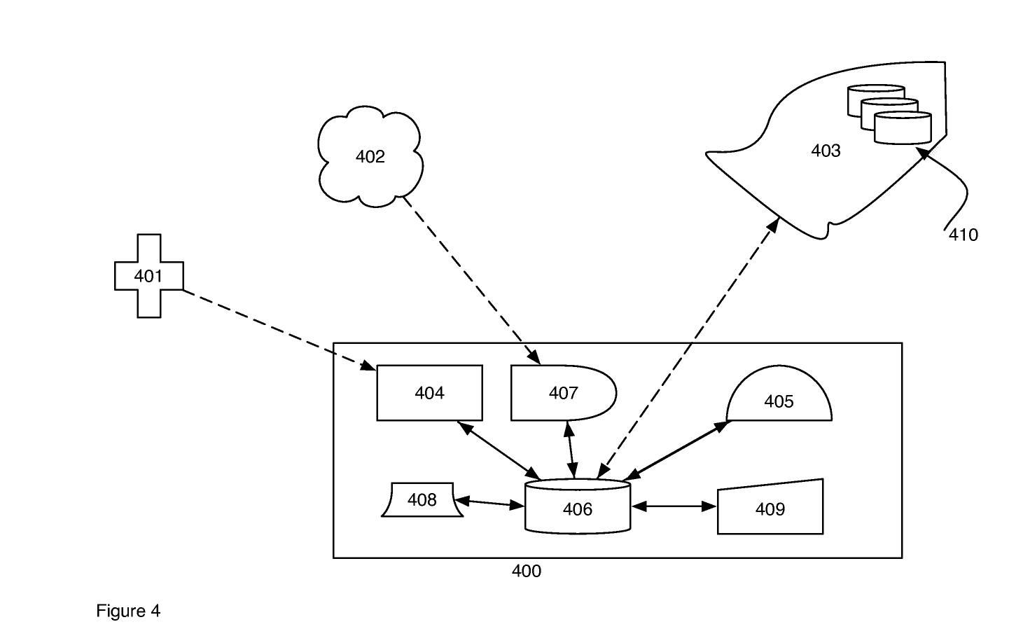

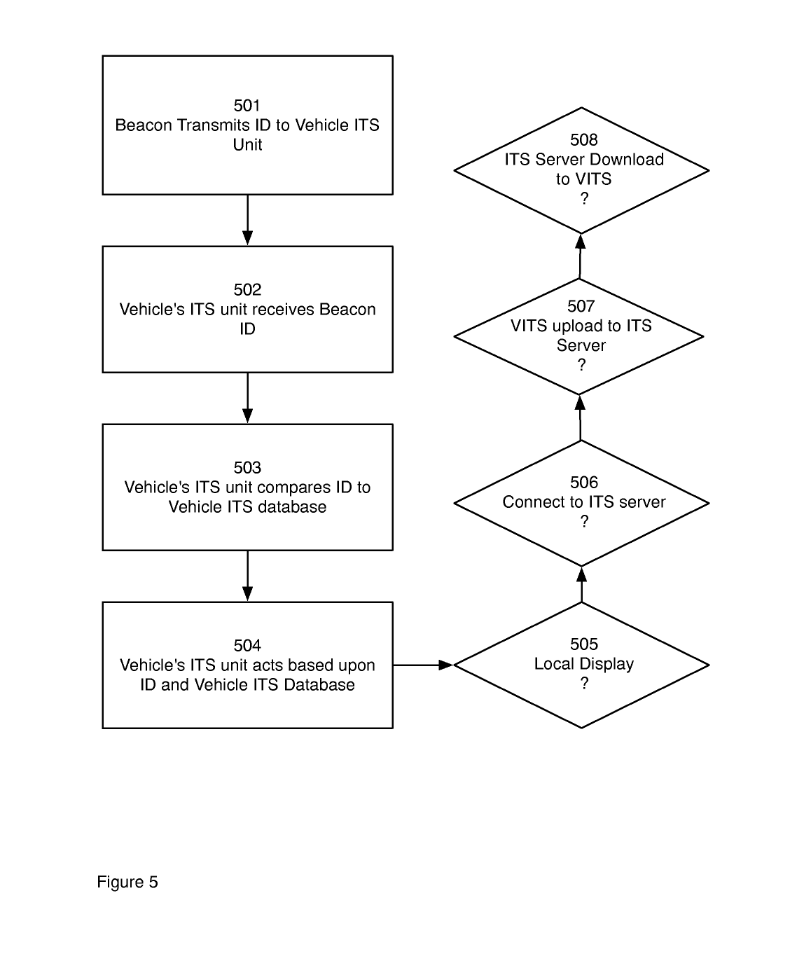

Referring now to FIG. 4 another embodiment is shown. The details of the analogous features of the previously discussed embodiments are not repeated but are included. The embodiment includes a beacon 401 in wireless communication with a receiver 404 located in a vehicle 400 or otherwise mobile system. The receiver 404 communicates a beacon identification code to a computing device 406 that includes computing capabilities as well as memory to store a database associating the beacon identification code and other data. The computing device is connected to a user interface 408, a display device 405 a global positioning device 407. The computing device 406 is further connected to the computing and telemetric capabilities 409 inherent in most current automobiles. The capabilities 409 include access to information about the vehicle such as operating conditions including speed as well as control of the vehicle such as connection to the acceleration and braking systems. The ITS computing device 406 is further connected wirelessly to a wireless network 403 and to global positioning satellites 402. Non-limiting exemplary wireless networks include cellular networks such as 3g and 4g connection, Wi-Fi networks and others that allow communication between the computer and the Internet or other perhaps closed or proprietary networked systems. In one embodiment 403 represents the publicly accessible Internet. In a second embodiment 403 represents a closed proprietary network dedicated to traffic information systems. The wireless network includes connection to a server 410. The server includes computing devices and associated memory such as that already discussed in conjunction with FIG. 2A. The server similarly to the onboard computing device 406 includes a database located in its memory and the database includes an association between beacon ID's, Vehicle ID's and programmed action that the server will taken conditioned upon this association. The computing system receives location of the vehicle through the global positioning system 407 and also can receive display instructions and other traffic control information through the connection to the network 403. Programming information and updates to the local database can be received from the network 403 as well as through the local user interface 408. The components of the local system contained within the vehicle 400 may be physically separate components or may be grouped in a single device such as a cell phone or portable computing device or may all be further integrated. Referring now to FIG. 5 an exemplary method of using the device of FIG. 4 is shown. The beacon transmits 501 an identification code to the vehicle. The vehicle receives 502 the signal and onboard computing device compares 503 the transmitted identification code to the onboard database. The computing device is programmed to select 505-508 one or more actions based upon the beacon ID. In one embodiment the computing device selects 505 to display some information to the vehicle operator. In another embodiment the computing device is programmed to connect 506 to an Intelligent Traffic System server. The connecting 506 further includes a programmed decision including uploading 507 traffic control information to the server of the beacon ID, a vehicle identification code and the vehicle location as determined both by the GPS system and from the correlation of the beacon identification code with the beacon location contained within the database. The Vehicle identification code may be a unique identification code encoded in the computing device memory of the onboard computing device. In one embodiment the vehicle identification code is the electronic serial number of a cell phone device. In another embodiment the vehicle identification code is the electronic serial number (ESN) of a cell phone as well as the mobile identification number (MIN) and system identification code (SID). In another embodiment the vehicle identification code is some combination including at least one of the MIN, SID and ESN. The server may further include a database of options or actions that are correlated with the beacon identification code and the vehicle identification code and encode to take particular actions based upon one or both. In one embodiment the ITS server downloads 508 traffic control information to the onboard vehicle computing device designated in the Figure as VITS. In one embodiment the server downloads traffic information to the onboard computing device of the VITS. In one embodiment the server obtains the traffic information from the data uploaded from all of the intelligent transportation system enabled vehicles that have communicated to the server in the manner discussed herein. In another embodiment the vehicle computing device uploads 507 a planned route and the server downloads 508 a suggested alternate route. In another embodiment the server downloads information to be displayed based upon a particular beacon identification code and particular vehicle ID. In this manner messages personal to a particular vehicle identification code are composed and stored at the ITS server to be downloaded to a particular vehicle upon its being located near a particular beacon. In another embodiment the downloading 508 includes updating the database contained in the computing device 406 onboard the vehicle. In this manner information rich messages may be preloaded for display within the vehicle. The bandwidth requirements for some information may be lessened by loading in a time shifted or delayed manner and only that information that is time critical then will use the critical or priority bandwidth of the intelligent traffic system. In one embodiment the downloading 508 includes updating the speed limit information associated with a beacon ID. In another embodiment the vehicle identification code is changed based upon the conditions of the vehicle. In one embodiment an emergency vehicle would have one identification code associated normally and a second identification code associated if the vehicle were in an emergency situation such as an ambulance or fire engine traveling to an emergency. An example content of the database associated with the server shown in a simplified single table mode is seen in Table 2.

TABLE 2
ITS Server Database

| | | | | | Actions to be |
|---|---|---|---|---|---|
| Beacon ID | Latitude | Longitude | Infrastructure | Vehicle ID | taken |
| 11adl | 40.10594 | −74.93851 | Stop light | V1a | Display stop light |
| 11adl | 40.10594 | −74.93851 | Stop light | V1b | Display stop light |
| | | | | | and IF (other |
| | | | | | vehicles nearby) |
| | | | | | THEN (warn of |
| | | | | | moving cross traffic) |
| 11adl | 40.10594 | −74.93851 | Stop light | V2 | Display stop light |
| 11adl | 40.10594 | −74.93851 | Stop light | V2 | IF (V1b nearby) |
| | | | | | THEN (alarm and stop) |

The database is seen to be analogous to that discussed earlier in Table 1. The new information is a Vehicle identification code and actions to be taken in conjunction with both a vehicle identification code and a Beacon ID. In one embodiment the Vehicle with identification code V1 is an emergency vehicle. The vehicle 1 has an identification code of V1a in a non-emergency situation and an identification code V1b in an emergency situation. Example emergency situations include a police, ambulance or other emergency vehicle rushing to a crime scene or a traffic accident, a fire emergency vehicle rushing to a fire, etc. V2 identifies a non-emergency type vehicle. It is seen that in a non-emergency vehicle 1 will transmit the vehicle identification code V1a. When vehicles transmitting ID's of either V1a or V2 approach the beacon with identification code 11adl the response of the server and instructions transmitted to the on-board computing devices of each vehicle would be to display the traffic light. However if the emergency vehicle is transmitting the identification code V1b indicating an emergency situation the server then is programmed to further warn the emergency vehicle of moving cross traffic and to sound an alarm in the vehicle with identification code V2 to stop. Further programming capabilities and complexities should now be apparent to the reader. For example in another embodiment the beacon identification code shown as 11adl is different for different states of the traffic light with corresponding different action programmed into the transmitted response of the server. The architecture of the system allows flexibility physical location of the database and the programmed responses to matches with data in the database. In another embodiment the database and the programs are contained in the memory of the server and programmed decision regarding actions are made at the physical location of the server. In another embodiment all such data and programmed steps are contained in the computing device located in the vehicle.

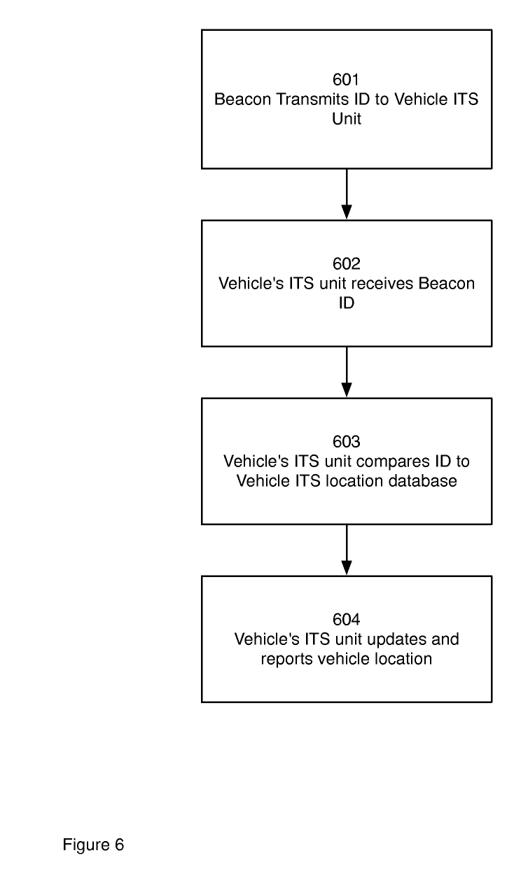

In another embodiment depicted in FIG. 6 the Intelligent Transportation System is used for location determination and location correction. Using the devices described in FIG. 4, the beacon transmits 601 an identification code to the Vehicle ITS unit. The Vehicle unit receives 602 the signal and compares 602 the beacon identification code with the database in the onboard computing device. The computing device can then update and report a location based upon reception of the beacon signal. A very low cost location service is thereby enabled. In another embodiment the update and reports 604 step updates the vehicle location to a cellular network. In another embodiment the computing device is contained within a cell phone and the update and reports step 604 updates the cell phone location tot select the best cellular path for operation of the cell phone.

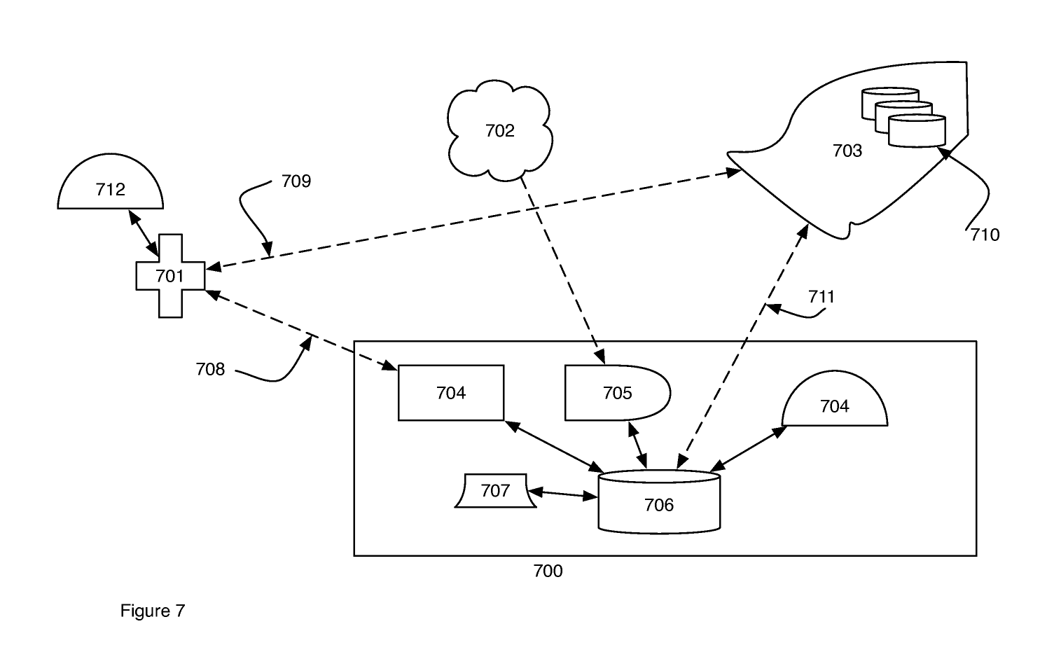

Another embodiment with added features is shown in FIG. 7. The embodiment includes all the features of the previous FIGS. 1-6 and now adds additional features and capabilities. A beacon 701 includes capability for transmitting and receiving both a local signal 708 and a network signal 709. Non-limiting examples of a local signal 708 would include a local wi-fi signal, Bluetooth and any other radio or optical signal known in the art. Similarly the network connection 709 could be a network signal through a local mesh network, a cellular signal such as a 3g or 4g transmission or any other public or proprietary two way radio signal known in the art. The beacon 701 now further includes computing and control capabilities of a traffic signal display to which it is attached. The computing capabilities contain a computing device and memory similar to the computing capabilities within the vehicle discussed in conjunction with FIGS. 2, 2A and 4. Non-limiting examples of the control capabilities include a display driver for a digital sign or display. The signal may change the status of the display or even determine what type of display is shown. In one embodiment an array of light emitting diodes (LED) or a liquid crystal display known in the art is used as a general purpose display whose use can be changed based upon the control. In one instance the display may be a stop sign and in another instance the controller may cause the display to show a yield sign. In another embodiment the display is used to show a one-way sign. In another embodiment the display may be used to indicate a changed direction of travel by showing a one-way sign that changes the pointed direction. The vehicle 700 includes a transceiver 704 that can receive a signal from the beacon, the signal including a beacon ID. The transceiver can also transmit signals to the beacon. In one embodiment the transmitted signal includes a vehicle identification code that the beacon controller can check in order to verify that the vehicle signal is authorized to change the state of the beacon controller. A non-limiting example of a vehicle identification code and controller scenario is where the vehicle 700 is an emergency vehicle and the vehicle transceiver sends a signal to the beacon controller to change a traffic light to red in the opposing directions to allow priority passage of the emergency vehicle through the intersection. The beacon receives the signal including a vehicle identification code and by comparison with the database now included in the beacon checks the authorization of the vehicle to make changes to the traffic light display.

The embodiment of FIG. 7 further includes a computing device 706, a user interface 707 a GPS receiver 705 connected to the computing device and a means 713 of displaying or otherwise communicating with the operator/user. The on board computing system is further connected to a network 703. Exemplary networks are as discussed previously. The network includes a server 710 That further includes memory and a computing processor. The memory includes a database that includes a table of vehicle identification codes and beacon identification codes and associated program steps to be acted upon by the computing processor. The computing device is connected via network links to both the on-board computing device 711 and to the beacon 709. The architecture of the system allows flexibility physical location of the database and the programmed responses to matches with data in the database. In another embodiment the database and the programs are contained in the memory of the server and programmed decision regarding actions are made at the physical location of the server.

In another embodiment all such data and programmed steps are contained in the computing device located in the vehicle. In another embodiment the database and programming steps are encoded within the memory of the computing device included in the beacon 701. In another embodiment the database and programming steps and the location of the steps of comparison with database information and associated actions are optimally located in the computing devices of the vehicle, the server and the beacon. A non-limiting example of such optimization is that signals from the beacon that are interpreted differently for the condition of the vehicle as discussed earlier for an emergency vehicle are made in the vehicle, whereas computation intensive steps such as calculating the optimum path for a vehicle from a present location to a target location are made at the server and database and programming steps related to the beacon associated display such as changing speed limit for a school zone are made at the beacon. The interconnectivity of the architecture allows optimum distribution of the database and programming steps. In one embodiment the optimization is made on the minimization of the communication bandwidth requirements. In another embodiment the identification code of the beacon is programmatically changed based upon the local weather, traffic conditions or time of day. Non-limiting examples of traffic conditions include slow moving traffic, an accident or presence of emergency vehicles.

In another embodiment there is transmission of a signal from the beacon to the vehicle, no receiver for a beacon signal nor computing device within the vehicle. The communication of traffic control information is between the server 710 and the beacon/signal controller 701. Another embodiment further includes a cellular device (not shown), such as cell phone located within the vehicle that does not communicate with the beacon but does communicate over a cellular network with the server. The multitude of cellular devices located within vehicles can then be located and their individual speed and directions determined. This information is used by the server to calculate current traffic conditions at the location of the vehicle and along the projected path of the vehicle. The local traffic information in one embodiment is transmitted to the cellular device. In another embodiment the cellular device is used as a user interface for a mapping application. The user inputs destination location. The cellular device transmits planned trip to the server that calculates an optimum path for such a trip based upon current location and traffic conditions along a planned route. In another embodiment the server updates the traffic information based upon receipt of cellular location and movement and based upon the updated traffic information calculates a newly optimized route to the destination and transmits the new route to the cellular device.

The flexibility of the architecture enables placement of the computing capabilities at multiple locations amongst the vehicle, the beacon and the server. In one embodiment the computing capabilities are isolated in the server. Another embodiment (not shown) limits the computing capabilities to the beacon. In another embodiment (not shown) the computing devices are limited to the server whereas electronic display devices are located at the beacon and in the vehicle.

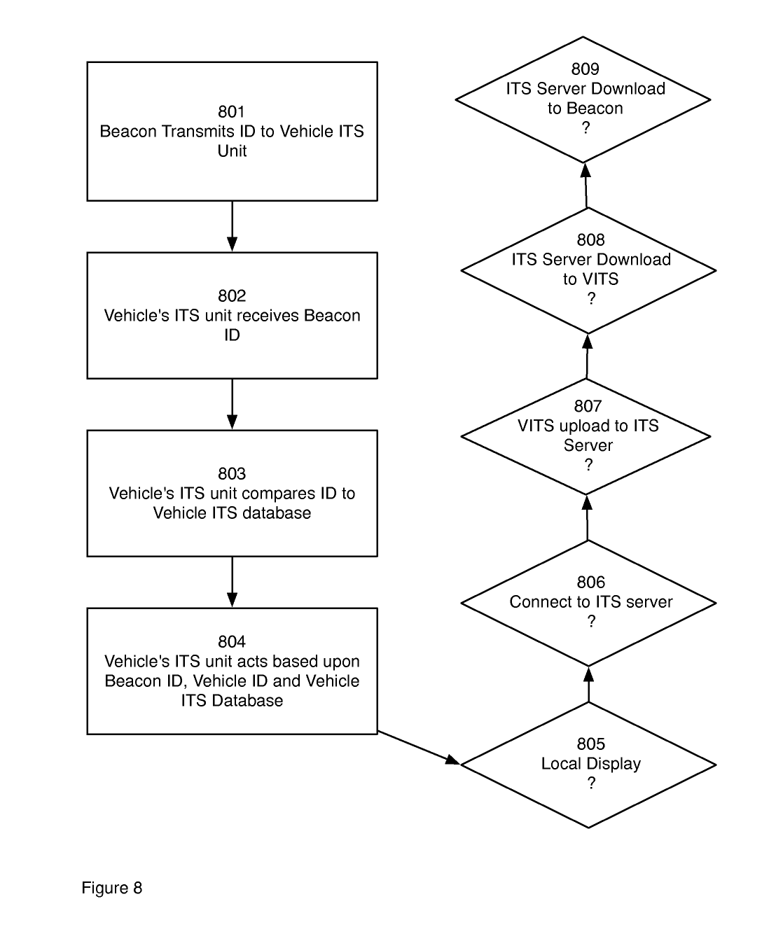

FIG. 8 shows a method of using the intelligent traffic system of FIG. 7. The Beacon transmits 801 a signal. The signal includes a beacon identification code. In another embodiment the signal includes a vehicle identification code and encoded messages specific to a particular vehicle transmitted to the beacon from the network server, the network server having become aware of the vehicle and its proximity to the beacon by a separate uploading step 807. The on-board vehicle ITS receives 802 the beacon transmission and the on-board computing device within the vehicle compares 803 the beacon identification code to the onboard vehicle database. The on-board vehicle computing devices includes programmed action to take based upon matches of the beacon identification code and the vehicle identification code in the transmitted message and acts 804 based upon instructions encoded in the memory of the computing device. The computing device then compares the received beacon identification code and the received vehicle identification code and takes actions 805, 806, 807 based upon the match of the two identification codes and the programmed actions within the computing device memory. If the database includes a program step action to upload 807 to the ITS server, the upload will include both vehicle identification code and a beacon identification code with additional information as instructed in the encoded program steps. The server upon receipt of the information then further compares the information received to its database and takes actions 808, 809 based upon matches. It is seen that action 808, 809 can in fact trigger another transmission to both the vehicle and the beacon. In one embodiment the message sent is specific to vehicles whose identification codes match those of an emergency vehicle. The emergency vehicle as well as all other vehicles in the locale of the beacon transmit vehicle motion data to the ITS server which in turns transmits messages specific to the emergency vehicle and a second message specific to non-emergency vehicles. In one embodiment the information transmitted is routing information. In another embodiment the information is vehicle control information such as to pull over and stop. In this fashion it can be seen that a route can be cleared for an emergency vehicle to be guided with priority through a high traffic zone by routing the emergency vehicle through one path and the non-emergency vehicles through different path(s).

In another embodiment there is minimal computation capabilities required in the vehicle. The vehicle is either equipped or associated with a GPS unit having cellular capabilities. The location and speed of the vehicle is determined using the GPS capabilities. The vehicle device then transmits the gps information including location and speed to the ITS server. The ITS server receives vehicle GPS information from a multitude of vehicles and then calculates traffic conditions for the locations of the vehicles. Based upon the traffic conditions and pre-set programming steps the server then conditionally send traffic conditions to the vehicle device. Non-limiting information that is sent to the vehicle device includes local traffic conditions such as relative speed traveling in various directions on streets local to the vehicle. In another embodiment the vehicle transmits speed, location and planned route including destination to the ITS server and the ITS server in turn downloads traffic conditions and suggested optimal route to the vehicle. Optimum may be picked as shortest travel time based upon traffic conditions known to the ITS server. The server also conditionally transmits traffic control information to the beacon. Traffic control information includes setting of speed limits, setting of directional lanes and control of timing and synchronization of traffic lights.

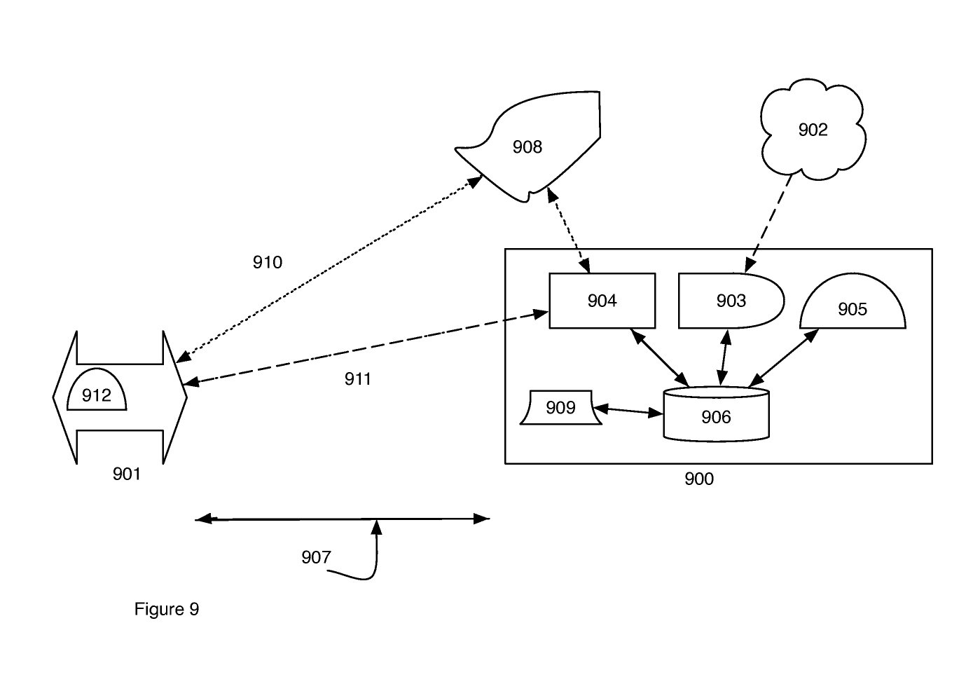

Embodiments where both the beacon and the vehicle are mobile is shown in FIG. 9. The system includes a beacon 901 that transmits and receives information to both a vehicle-based system 911 and to a networked system 910. The beacon 901 now further includes an alert device 912. Non-limiting exemplary alert devices include a display, a lighting device such as a light emitting diode and an audible device such as a buzzer. The network 908 includes a network server, not specifically shown but discussed in conjunction with previous embodiments. The contents of the vehicle and the network include those features previously discussed. Non-limiting examples of the beacon 901 include a hand carried device such as a cell phone, a pager or any electronic device capable of transmitting and receiving electronic data wirelessly. The vehicle 900 includes in on-board equipment a receiver 904 that can communicate to a network as well as receive communication from the beacon 901. The on-board equipment further includes a global positioning device 903 that communicates with global positioning satellites 902 to establish the geographical position of the vehicle 900. On-board computing capabilities 906 a user interface 909 and a display device 905. The vehicle and the beacon are separated by a distance 907. The system is aware of the location of the vehicle through the GPS system and is aware of the location of the beacon through transmissions received (or not) by the vehicle.

The flexibility of the architecture enables placement of the computing capabilities at multiple locations amongst the vehicle, the beacon and the server. In another embodiment, the features of the embodiment of FIG. 9 are shown except that the electronic link between the beacon and the vehicle is not used.

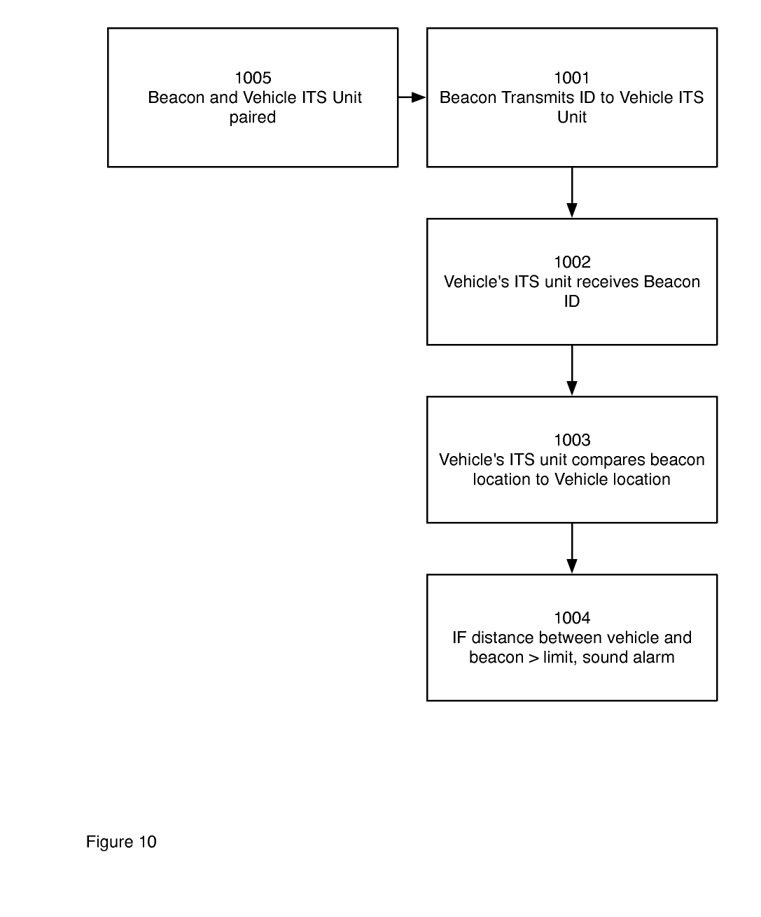

A method of using the system of FIG. 9 is shown in FIG. 10. The beacon transmits 1001 a signal including a beacon identification code to the vehicle ITS unit The vehicle unit receives the signal 1002 and compares 1003 the beacon location to vehicle location. Matching of identification codes is done as in previous embodiments. The vehicle computing device then acts 1004 based upon the distance between the vehicle and the beacon. In particular if the distance between the beacon and the vehicle is greater than a programmed limit an alarm will be sounded through either the beacon display or the vehicle display or both. Based upon the use of vehicle and beacon identification codes and programmed access to data bases as previously discussed beacons and vehicles may be matched and alarms can be sounded based upon their relative locations.

Another embodiment, the beacon and the vehicle are paired. The pairing may be done either at the server or at the beacon. The beacon transmits an ID and location to the ITS server Unit. Similarly the vehicle ITS unit transmits a vehicle identification code and location to the ITS server. The server then compares the vehicle identification code and the beacon identification to be certain the two have been paired and then based upon the beacon location and the vehicle location calculates the distance between the vehicle and the beacon. The server then compares the calculated distance to a limit and if the limit exceeds a pre-set value sends and alarm message to the beacon.

### SUMMARY

An intelligent transportation system that utilizes identification codes, databases and preprogrammed action steps contained within those databases is presented. The system thereby allows rich transportation communications to be made to the operators of vehicles while making optimum use of available networking bandwidth.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

What is claimed is:

1. An intelligent transportation system, said system comprising:
a) a beacon capable of transmitting a signal said signal including a beacon identification code,
b) a receiver capable of receiving the signal from the beacon, said receiver located in a vehicle,
c) a computing device, located in the vehicle and electronically connected to the receiver, said computing device including memory,
d) a database encoded within the memory of the computing device,
e) programming steps encoded within the memory of the computing device and associated in the database with the beacon identification code,
f) wherein when receiving the signal from the beacon the receiver transfers the signal to the computing device and the computing device matches the beacon identification code with the programming steps in the database and executes the programming steps that are matched with the beacon identification code.

2. The intelligent transportation system of claim 1 where the beacon identification code changes with at least one condition selected from: time of day, traffic conditions and weather conditions.

3. The intelligent transportation system of claim 1 further comprising a vehicle identification code encoded within the memory of the computing device wherein the programming steps are further associated with the vehicle identification code.

4. The intelligent transportation system of claim 3 wherein the vehicle identification code changes with at least one condition selected from: the speed the vehicle is traveling, the direction the vehicle is traveling, whether the vehicle is in an emergency situation.

5. An intelligent transportation system, said system comprising:
a) a beacon capable of transmitting and receiving electronic signals and including a beacon computing device,
b) a traffic signal display device electronically connected to the beacon,
c) a server computing device capable of transmitting and receiving electronic signals,
d) a vehicle transceiver capable of transmitting and receiving electronic signals, said receiver located in a vehicle,
e) a vehicle computing device, located in the vehicle and electronically connected to the vehicle transceiver and to a display located within the vehicle,
f) a database encoded within the memory of at least one of the beacon computing device, the vehicle computing device and the server computing device, said database including at least one of: a beacon identification code, a vehicle identification code and a server identification code,
g) programming steps encoded within the memory of at least one of: the vehicle computing device, the beacon computing device and the server computing device, said programming steps associated in the database with at least one of: the beacon identification code, the server identification code and the vehicle identification code,
h) wherein upon receiving a transmitted signal at least one of: the vehicle computing device, the beacon computing device and the server computing device, executes programming steps that are associated in the database with at least one of: the beacon identification codes, the server identification code and the vehicle identification code.

6. The intelligent transportation system of claim 5 wherein the programming steps include displaying a local speed limit to a driver in the vehicle.

7. The intelligent transportation system of claim 5 wherein the programming steps include displaying at least one of: a stop sign, a yield sign, a one way sign and a speed limit on the traffic signal display device.

8. The intelligent transportation system of claim 5 wherein the vehicle transceiver and the vehicle computing device are located in an emergency vehicle and the programming steps include displaying a warning of the emergency vehicle's presence on the display in a vehicle that is not the emergency vehicle.

9. The intelligent transportation system of claim 5 wherein the programming steps include calculating a route to a target destination.

10. An asset tracking system comprising:
a) a server comprising a computing device and a transceiver,
b) a mobile beacon said beacon including a display, a global positioning system and a beacon transceiver said beacon transceiver transmitting the location of the beacon to the server,
c) a global positioning device and a transceiver located within a vehicle said vehicle transceiver transmitting the location of the vehicle to the server,
d) wherein the server computing device is programmed to calculate the distance between the beacon location and the vehicle location and if said calculated distance exceeds a pre-set limit to send an alarm message through the server transceiver to the beacon transceiver and thereby activating the beacon display.
